(19) United States
(12) Patent Application Publication
(10) Pub. No.: US 2012/0103974 A1
(43) Pub. Date: May 3, 2012

(54) TOOL AND METHOD FOR HEAT TREATING AT LEAST PART OF A METALLIC STRUCTURAL PART

(75) Inventors: OTTO BUSCHSIEWEKE, Paderborn (DE); Mathias Lohberg, Altenbeken (DE)

(73) Assignee: Benteler Automobiltechnik GmbH, Paderborn (DE)

(21) Appl. No.: 13/283,015

(22) Filed: Oct. 27, 2011

(30) Foreign Application Priority Data
Oct. 28, 2010 (DE) 10 2010 049 640.5

(51) Int. Cl. H05B 6/10; H05B 6/36

(52) U.S. Cl. 219/647; 219/672

(57) ABSTRACT

A tool for local heat treatment of a metallic structural part includes a first inductor arranged above a first side of a region of the structural part undergoing local heat treatment at a first distance to the first side, and a second inductor arranged at a second side of the region in opposition to the first side. At least one of the first and second inductors has induction loops arranged in the shape of a meander.

### CROSS-REFERENCES TO RELATED APPLICATIONS

This application claims the priority of German Patent Application, Serial No. 10 2010 049 640.5, filed Oct. 28, 2010, pursuant to 35 U.S.C. 119(a)-(d), the content of which is incorporated herein by reference in its entirety as if fully set forth herein.

### BACKGROUND OF THE INVENTION

The present invention relates, in general, to the field of heat treatment of a metallic structural part.

The following discussion of related art is provided to assist the reader in understanding the advantages of the invention, and is not to be construed as an admission that this related art is prior art to this invention.

Conventional methods involving inductive heating of metallic structural parts have proven problematic to evenly heat structural parts to be connected irrespective of their cross section. This is especially true when for economical reasons short heating times are desired. Especially when large and/or substantially rectangular joining surfaces are involved, current conduction and thus heating of the joining surfaces is uneven, using conventional induction loops.

It would be desirable and advantageous to address prior art problems and to obviate other prior art shortcomings.

### SUMMARY OF THE INVENTION

According to one aspect of the present invention, a tool for local heat treatment of a metallic structural part includes a first inductor arranged above a first side of a region of the structural part undergoing local heat treatment at a first distance to the first side, and a second inductor arranged at a second side of the region in opposition to the first side, wherein at least one of the first and second inductors has induction loops arranged in the shape of a meander.

The present invention resolves prior art problems by providing two interacting inductors producing induction fields which complement one another in the region in which the structural part undergoes heat treatment in such a way that regions of the structural part are avoided that should not be exposed to an induction field. As a result, the material microstructure becomes especially homogenous because any zone in the region that is not reached by the first inductor and thus would remain cold can now be reached by the second inductor and heated. Thus, an overall more homogenous heating pattern is realized in the heat-treated region. By providing at least one of the first and second inductors with induction loops arranged in the shape of a meander, it becomes possible to generate inductive heating across a local region. The term “meander” is used in the description as relating to any shape that involves a replicating or also repeating pattern of induction loops. The essential region of the inductor surface is characterized by electric conductors or conductor sections in substantially parallel relation, with their ends being connected by transitions which may have, for example, the shape of arcs or rectangular connections.

The inductors are normally of flat configuration so that a component surface which may for example be formed by several individual component surfaces at an angle to one another can be heated with an inductor according to the present invention. This is beneficial because the surfaces need not be completely planar but curved surfaces or also surfaces at an angle to one another can be arranged.

According to another advantageous feature of the present invention, the first and second inductors may be arranged in offset relationship. The offset disposition of the two inductors further reinforces the effect of complementing the induction fields. The regions undergoing heat treatment are hereby reached in particular so that hot and cold regions of the induction fields of each inductor complement one another through overlap.

According to another advantageous feature of the present invention, the offset relationship can be realized by positioning a positive amplitude in the meander shape of the first inductor in opposition to a negative amplitude in the meander shape of the second inductor. The offset is implemented in such a way that the fields of the two inductors results in a maximum and most homogenous field strength through addition of the local field strengths.

According to another advantageous feature of the present invention, the offset relationship can correspond to 0.25 to 0.75 times a length of a period of the meander shape. Currently preferred is an offset which corresponds to half a length of a period of the meander shape. Advantageously, the period of the meander shape of the induction loops of the first inductor substantially corresponds to the period of the meander shape of the induction loops of the second inductor.

According to another advantageous feature of the present invention, the distance of neighboring current conductors or current conductor sections of an inductor may vary during the course of the inductor. This causes locally varying field strengths. The resultant locally varying heat inputs provide wanted locally different material properties.

According to another advantageous feature of the present invention, at least one of the first and second inductors can be supported for movement in the tool. As a result, the inductors can be moved separately in relation to one another, individually, or jointly, or parallel to one another. This relative movement may be executed during inductive local heat treatment or after conclusion of the inductive local heat treatment. The relative movement provides in addition a more homogenous heat image within the microstructure. Regions between cold and hot zones of the respective inductors that are thus not particularly heated can be reached for example by overlapping two hot zones of the first and second inductors as a result of the relative movement.

According to another advantageous feature of the present invention, the second inductor can be arranged at a second distance to the structural part. The first and second distances may differ from one another or correspond to one another. Depending on the heat image to be generated on the structural part itself, it may be suitable to select identical and/or different distances. For example, a greater distance of the second inductor causes less heat input on the side of the structural part on which the second inductor is arranged in relation to the side of the structural part on which the first inductor is arranged. Depending on the structural part properties to be realized, this may have an especially positive effect on the process and/or the structural part properties to be accomplished, in particular ductility of the structural part.

According to another advantageous feature of the present invention, the first distance and/or the second distance may vary during the course of an inductor. This, too, allows locally different dimensioning of the field strength, causing locally varying heat inputs into the structural part so that the structural part can be provided with areas of different material properties.

According to another advantageous feature of the present invention, the first and/or second distance may be variable. The first and/or second distance may hereby be adjusted as base setting. A tool according to the present invention can then be incorporated in a production process and thus can be best suited to the cycle time of the process and the desired outcome

According to another advantageous feature of the present invention, the first and/or second distance may also be adjusted when the local heat treatment is carried out. This results in a same benefit as attained with the relative movement. Regions that still are not reached in an optimum way by the arrangement of the two inductors can now be reached through change of the distance and corresponding shift of the induction field. As a consequence, a more homogenous heat image is attained within the structural part.

According to another advantageous feature of the present invention, the induction loops may have a tubular configuration. Suitably, the induction loops are implemented as tubes, wherein coolant may flow through the tubes. Advantageously, the tubular induction loops can be made of copper alloy. In this way, it is possible to introduce the respectively desired heat input into the structural part, without risking overheating of the inductor. Frequency, amplitude and also heating time in the region being locally treated can be chosen such that the desired strength properties and also ductility properties in the structural part can be realized.

It is further within the scope of the present invention to place an inductor in the tool, with the course of the induction loops corresponding to the meander shape of two inductors. In this way, the components of the induction loop in surrounding relationship to the structural part can be arranged at an offset between the upper and lower induction loops.

According to another aspect of the present invention, a method for local heat treatment of a metallic structural part includes inserting the structural part in a holder in a position in which a region of the structural part is intended to undergo local heat treatment by a first inductor, placing a restraining mechanism with a second inductor above the region such that the first and second inductors are arranged in offset relationship in longitudinal direction of the structural part, and heat treating the region.

The metallic structural part can thus be placed in a holder which may be part of the tool or an external member which additionally accompanies the heating tool with the inductor or inductors. After placement of the structural part in the holder which may also be configured as clamp, a restraining mechanism is arranged above the structural part region to be heat-treated. The restraining mechanism can be associated to a second inductor, with the inductors being arranged on the structural part as a result of the disposition of the first inductor on the structural part holder and the second inductor on the restraining mechanism. The inductors can be arranged at an offset, whereby the offset can be selected such that a positive amplitude in the meander shape of the first inductor is positioned in opposition to a negative amplitude in the meander shape of the second inductor.

According to another advantageous feature of the present invention, at least one of the first and second inductors executes a relative movement during heat treatment. Both inductors may be moved separately from one another or also moved parallel to one another. Also a movement of both inductors in opposite directions can be executed. This ensures that the entire region of the structural part being heat-treated is subject to a homogenous heat input by the induction loops.

According to another advantageous feature of the present invention, the first and second inductors can move in relation to the structural part at an absolute constant distance from one another, wherein the relative movement is less than 20 mm. Both inductors are hereby held in a fixed absolute position relative to one another and move in relation to the structural part, with the movement range being less than 20 mm. As a result, the method according to the invention is executed only stationary, with the relative movement not intended to realize a greatest possible induction range but only to generate a homogenous heat input into the structural part.

According to another advantageous feature of the present invention, the relative movement can be executed in an oscillating manner. This ensures that the movement is carried out at least over two axes in a plane. It is, of course, also conceivable to execute a spatial movement so that each single cubic surface element in the structural part is reached without exception by the induction field generated by the two inductors.

According to another advantageous feature of the present invention, the distance of the first and/or second inductor in relation to the structural part can vary.

According to another advantageous feature of the present invention, the metallic structural part can be heat-treated in such a way that the regions of the structural part undergoing heat treatment is initially heated up to a temperature in a temperature range between 500° C. and 900° C., preferably between 550° C. and 800° C. Currently preferred is a temperature range between 700° C. and 800° C. The structural part is maintained at the heat-up temperature for a hold time and subsequently cooled down from the heat-up temperature in at least one phase.

A method according to the present invention has the advantage that the structural part can be tailored to have desired material properties and can be produced in a reliable manner. The structural part produced through hot-forming and press-hardening has a hard and brittle structure. The local heat treatment in accordance with the method of the invention below the austenitizing temperature transforms the material microstructure of the structural part in the heat-treated regions so as to provide a more ductile microstructure. Heating commences within the scope of the invention at a starting temperature which the structure has after undergoing press-hardening. For example, heating may commence at the ambient temperature. The starting temperature for heating is however always smaller that the martensite starting temperature (MS), preferably below 200° C.

The temperature range between 500° C. and 900° C. for heating up and retention of the preheating temperature results in a beneficial stress relief in the intended heat-treated regions, for example at the joining flanges or also marginal areas of openings which undergo a heat treatment according to the invention.

For example when the structural part involves a motor vehicle component for installation as structure or safety part in a self-supporting body, the heat-treated region positively influences the crash property of the body in the area of application of the vehicle component. If, for example, a region in the form of a joining flange has undergone heat treatment according to the method of the invention, this joining flange does not show any tendency to tear or detach or to crack in the event of a crash and thus maintains the integrity of the surrounding structural parts or safety parts. This is especially beneficial for the safety of passenger in the vehicle interior. The term “joining flange” is to be understood within the scope of the invention as a flange area intended for attachment of another structural part or component. Attachment may hereby involve bonding, riveting, welding, soldering, or similar connection processes.

A further benefit relates to those regions which undergo an intended deformation in the event of a crash. This deformation is provided to conduct energy into the body for dissipation, thereby further enhancing the safety for vehicle occupants. Another application involves for example the targeted deformation of individual regions to enable cost-effective repair works after an accident.

Regions heat-treated by the method according to the invention can hereby deform in the event of a crash as to crumple and thus to absorb energy in a targeted way. Furthermore, the heat-treated regions are less likely to crack as their microstructure is more ductile compared to hot-formed and press-hardened hard and brittle structures.

The method according to the invention is applicable for large-scale production in a reliable manner. Manufacturing tolerances are substantially avoided, thereby ensuring high manufacturing accuracy of vehicle components produced in accordance with the method of the invention, when a vehicle body with particular crash points is constructed using for example a targeted CAD computation.

Executing the local heat treatment on joining flanges of the structural part has the advantage that the joining flanges have a ductile material property. When thermal joining as connection by material joint is involved, the microstructure is transformed in the heat impact zone of the joining process. The presence of a ductile section of the structural part is beneficial with respect to the welding process and to the material microstructure realized in the heat impact zone after the welding process. Also this section is transformed by the local heat treatment according to the method of the invention into a region with ductile material microstructure. This provides benefits in the event a motor vehicle encounters a crash as the connecting weld seams are durable. The term “weld seam” relates within the scope of the invention to a weld seam produced by any one of available thermal joining processes. This may also include continuous longitudinally welded seams but also spot welding or intermittent weld seams.

According to another advantageous feature of the present invention, the local heat treatment may be executed at openings of the structural part. These openings may be provided in the structural part for various reasons, for example to optimize weight or to permit passage of other components such as control levers or cable harnesses or the like. In particular the area of the openings and also in the end region of openings may encounter cracks in the event of a crash which can propagate across the entire structural part. Reducing the surface tension provides in this region a ductile material structure which counters crack formation and unwanted deformation of the structural part.

Also stress as a result of bending loads which may be introduced into the vehicle body by body torsion or other driving impacts such as engine vibration can be advantageously influenced. Using local heat treatment according to a method of the invention positively affects longevity of a vehicle body as a result of the reduction of surface tension.

According to another advantageous feature of the present invention, a vehicle component may include at least two interconnected structural parts, with the heat treatment being carried out in the areas of the coupling. The at least two structural parts may involve, for example, at least two hot-formed and press-hardened structural parts. It may also involve a combination of a hot-formed and press-hardened structural part with a structural part produced conventionally or by a metal working process. Advantageously, the hot-formed and press-hardened structural part can be provided with the same positive effects as mentioned above.

Subjecting the coupling areas to a method according to the invention has a positive effect on their stress resistance and longevity. In the area of coupling through thermal joining, a heat impact zone is established in a weld seam, accompanied again by a transformation of the microstructure. Taking into account the applied coupling process, e.g. inert gas welding, laser welding, spot welding, seam welding, or the like, various material properties can be introduced which cause sometimes undesired side effects. On a large-scale production, the benefits of the respectively used welding process outweigh economically any shortcomings. These shortcomings can however be eliminated cost-effectively in large-scale production by the method according to the invention.

Heat treatment of the weld seams has a positive effect on longevity, corrosion resistance and deformation capability.

According to another advantageous feature of the present invention, heating up can be carried out over a time period of up to 30 seconds, preferably up to 20 seconds, especially preferred up to 10 seconds. Currently preferred is a time period of 5 seconds. Heating up may take place in accordance with the method of the invention with a progressive, linear, or degressive temperature rise over time. A short heating up phase to reach the heat-up temperature in combination with the subsequent hold time in which the heat-up temperature is maintained for a hold time has a positive effect on process reliability of the local heat treatment.

According to another advantageous feature of the present invention, the hold time may last up to 30 seconds, preferably up to 20 seconds, especially preferred up to 10 seconds. Currently preferred is a time period of 5 seconds. By controlling the transformation of the material microstructure at constant temperature, influenced only by the duration of the hold time, the quenching and tempering process can be executed in a reliable manner. A further temperature rise or also temperature drop in a range of a temperature difference to the heat-up temperature of up to maximal 100° C. during hold time may also be conceivable within the scope of the invention.

A further benefit of short time periods for heat-up and hold time resides in the substantial elimination of a heat transfer in the form of heat conduction. In addition, the method according to the invention can be integrated in the cycle time of existing production processes with heat transformation steps and further following manufacturing steps. The cycle times may hereby range in a time window between 5 seconds and 30 seconds. Currently preferred is a time window between 20 seconds and 15 seconds.

Heat-up and retention may take place in a single apparatus which may also be used to hot-form and press-harden the structural part. The structural parts may also be transferred to a separate apparatus following hot-forming and press-hardening for heating up and holding the heat-up temperature. Heat-up and retention of the temperature may be carried out for example by inductive heating or similar heating options which can be integrated into the production process depending on the application at hand.

According to another advantageous feature of the present invention, cooling can be executed in at least two phases. The two cooldown phases may last equally long or may last differently. For example, the first cooldown phase may last longer than the second cooldown phase. The cooldown phases may again be carried out in a single apparatus or carried out in the apparatus for heat treatment or in a separate cooldown tank. Also conceivable is the provision of at least two different cooldown phases in two separate cooldown tanks.

By executing the cooling process of the heat treatment according to the invention in several phases, it is again possible to realize the desired microstructure transformation step and thus the desired material property in the regions undergoing local heat treatment in a reliable, cost-efficient and precise manner. It is also possible, as a consequence of the multiphase cooldown operation, to integrate the cooldown process into the ongoing production of a structural part to be produced in such a manner as to suit the cycle times of preceding and following processing steps individually over a broad spectrum, without adversely affecting quality of the attainable microstructure transformations.

According to another advantageous feature of the present invention, the second cooldown phase can be executed over a time period of up to 120 seconds. Currently preferred is a time period of up to 60 seconds.

According to another advantageous feature of the present invention, the first cooldown phase component results in a cooldown of the vehicle to a temperature between 200° C. and 900° C., preferably between 300° C. and 800° C. Currently preferred is a cooldown to a temperature between 500° C. and 700° C.

In a second phase, the vehicle component is cooled down to a target temperature which may lie below 200° C. Once the structural part is at a temperature below 200° C., warping which adversely affects production reliability of the process and is caused by heat is no longer encountered. It is, however, also conceivable to cool down to room temperature. The cooldown profile of the temperature differential and temperature profile over cooldown time may be progressive, linear, or degressive. Once the first cooldown temperature has been reached, the possibility of warping of the structural part is substantially eliminated.

According to another advantageous feature of the present invention, inductive heating is assisted by infrared heating. Infrared heating may be carried out by infrared radiators which enable a lamp heating. In this way, very small local regions having defined boundaries can be heat treated. The transition zone between the hot-formed and press-hardened but not heat treated region and the locally heat treated region can be below 100 millimeters, preferably below 50 millimeters. Currently preferred is a transition zone between 1 and 20 millimeters. Thus, sharp-edged regions can locally undergo heat treatment in a targeted manner.

Basically, a local heat treatment according to the invention may be complemented by further heat sources, e.g. infrared radiators, in order to heat areas of the structural part that are difficult to reach.

According to still another aspect of the present invention, a tool arrangement for local heat treatment of a metallic structural part includes a tool having a first inductor arranged in a marginal area above a region of the structural part undergoing local heat treatment and including induction loops having a meander shape to encompass the structural part from a top side of the structural part to a bottom side thereof, wherein the induction loops on the opposite sides are arranged at an offset which is 0.25 to 0.75 times a length of a period of the meander shape.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a simplified schematic illustration of an arrangement of two inductors in relation to a metallic structural part;

FIG. 2 is a principle illustration of two inductors at offset relationship;

FIG. 3 is a simplified schematic illustration of one variation of the present invention with two inductors for carrying out a method according to the present invention;

FIG. 4 is a simplified schematic illustration of another variation to execute the method according to the present invention;

FIG. 5a, 5b, 5c are graphical illustrations of various temperature profiles of individual heat treatment steps, showing the temperature as a function of the time; and

FIG. 6 is a simplified schematic cross sectional view of an arrangement of first and second inductors with a structural part placed in-between.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

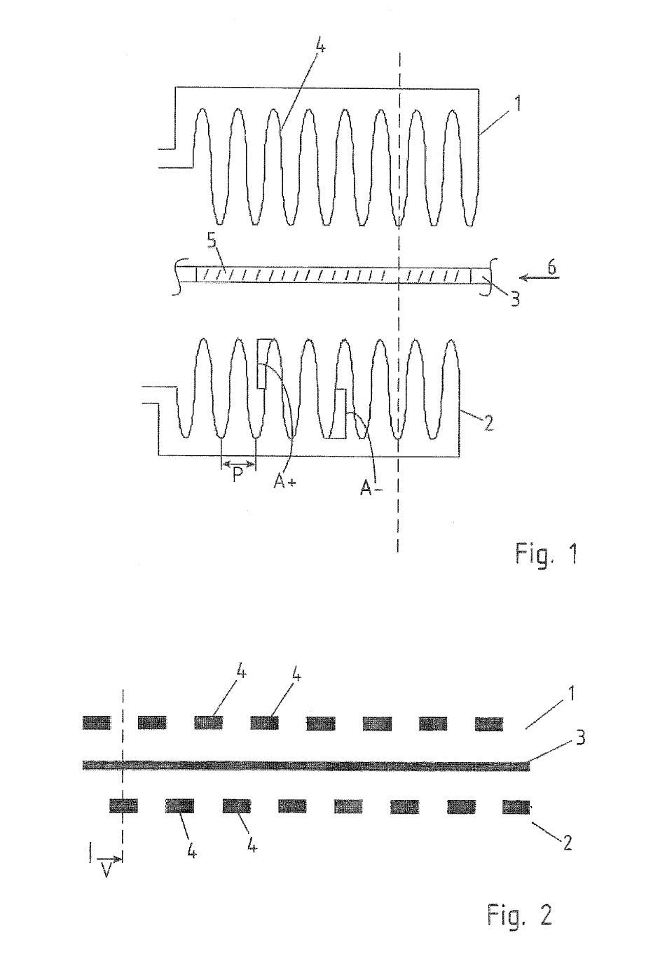

Turning now to the drawing, and in particular to FIG. 1, there is shown a simplified schematic illustration of an arrangement of a first inductor 1 and a second inductor 2 which are arranged at a metallic structural part 3. The first inductor 1 and the second inductor 2 have each inductions loops 4 laid out in the shape of a meander. By way of example, this meandering pattern is sinusoidal and has a period P and amplitude A. In principle, the induction loops 4 may also be configured rectangular with electric conductor sections in substantially parallel relationship, with the ends of the conductor sections being interconnected by transitions in the form of arcs or rectangular connections for example. The amplitudes A, pointing upwards in relation to the drawing plane, are hereby the positive amplitudes and the downwardly pointing amplitudes A represent the negative amplitudes A. The metallic structural part 3 thus undergoes heat treatment in the region 5 illustrated as hatched area. The first inductor 1 is arranged at an offset V (FIG. 2) to the second inductor 2 in relation to the length direction, indicated by arrow 6, of the structural part 3. The offset V is selected such that a negative amplitude A of the first inductor 1 opposes a positive amplitude A of the second inductor 2.

FIG. 2 shows a principle illustration of the offset V. As can be seen, the offset arrangement of the first and second inductors 1, 2 is such that the region 5 that is not reached by the induction loops 4 of the first inductor 1 are reached on the opposite side by the induction loop 4 of the second inductor 2. As a result, the structural part 3 placed between the first inductor 1 and the second inductor 2 is heat treated with a homogenous heat input.

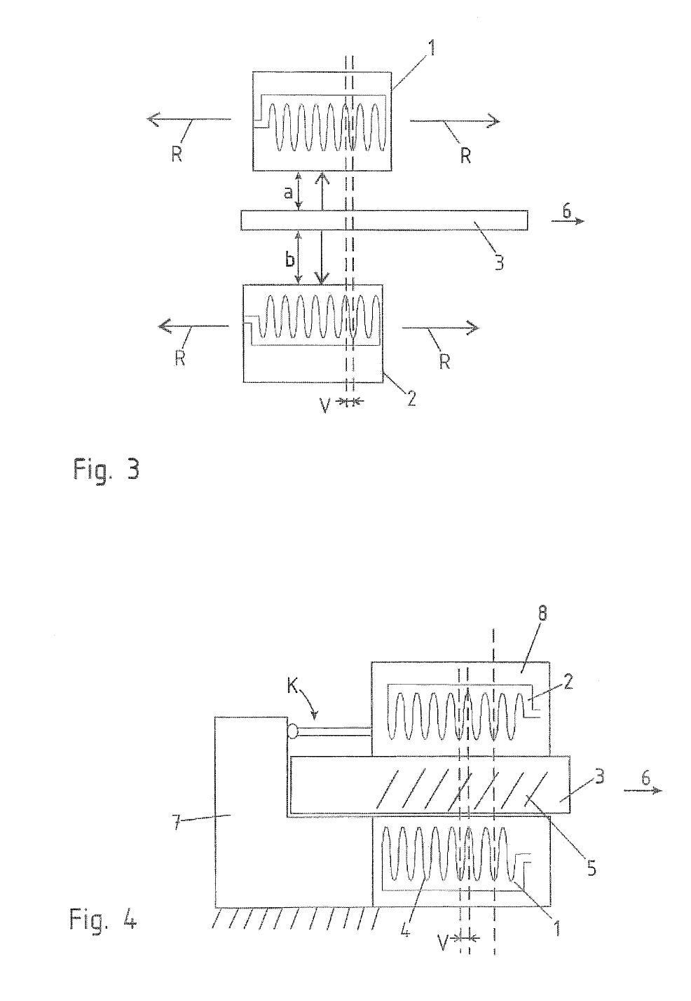

FIG. 3 shows a variation of the present invention, with a first inductor 1 being arranged on a structural part 3 in opposition to the second inductor 2. The first inductor 1 as well as the second inductor 2 may execute relative movements R in length direction, as indicated by arrow 6, of the structural part 3. The relative movements R may be carried out parallel to one another or offset to one another. Furthermore, the first inductor 1 is arranged at a distance a to the structural part 3, and the second inductor 2 is arranged at a distance b to the structural part 3. Through variations of the distances a and b, it is possible to separately carry out the relative movements R in relation to the structural part 3 or also the inductors 1, 2 in relation to one another or from the inductors 1, 2.

FIG. 4 is a simplified schematic illustration of another variation to execute the method according to the present invention. In this embodiment, provision is made for a holder 7 having a first inductor 1. A metallic structural part 3 is placed into the holder 7 and held in place by a restraining mechanism 8 having a second inductor 2. The restraining mechanism 8 may hereby be folded down onto the structural part 3, for example by a folding movement K, to clamp the structural part 3. A region 5, shown by hatching, of the structural part 3 undergoes local heat treatment with the first inductor 1 and the second inductor 2. The meandering induction loops 4 of the inductors 1, 2 are hereby arranged at an offset V in length direction of the structural part 3.

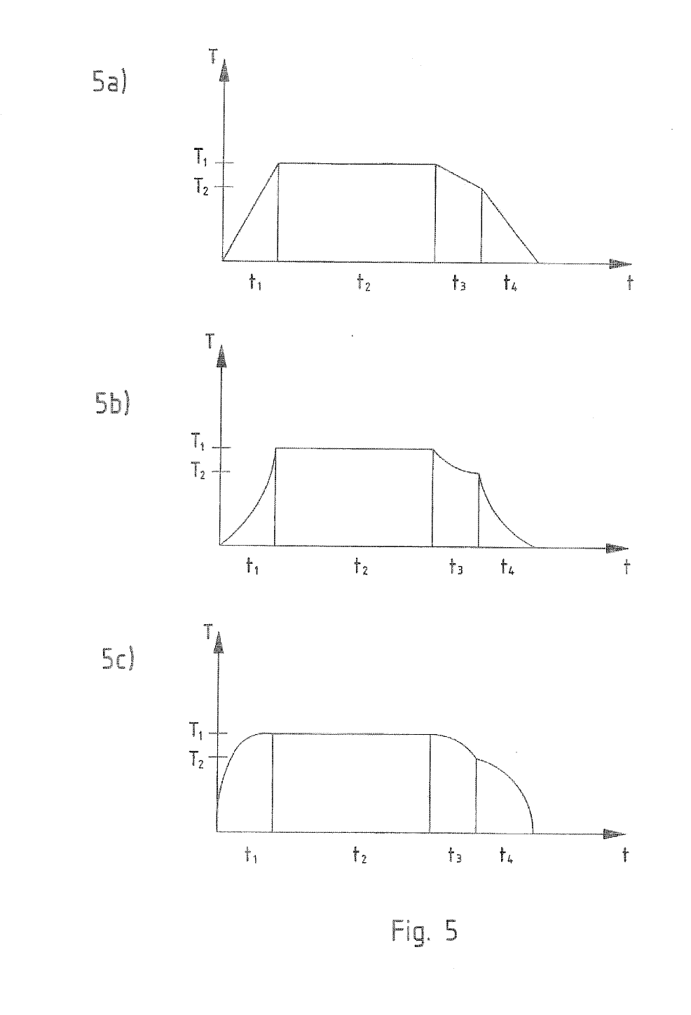

FIG. 5a is a graphical illustration of a temperature profile of individual heat treatment steps, showing the temperature T as a function of the time t. Depicted are heat-up time t1, hold time t2, cooldown time first phase t3, and cooldown time second phase t4 on the X-axis, and heat-up temperature T1 and first cooldown temperature T2 on the Y-axis.

A hot-formed and press-hardened motor vehicle component essentially at a temperature below 200° C. is heated in the heat-up phase to the heat-up temperature T1. At a starting temperature of below 200° C. but above room temperature, the residual heat energy of the hot-forming and press-hardening processes is utilized for the local heat treatment.

Heating involves a linear temperature rise over the time. After conclusion of the heat-up time t1, the heat-up temperature ills maintained for a hold time t2. The heat-up temperature T1 is kept substantially constant over the entire hold time t2. Temperature fluctuations in the form of a temperature rise or temperature drop are not depicted here and may occur during the hold time t2 for reasons of desired transformation of the material microstructure or for cost reasons of the production process.

The conclusion of the hold time t2 is followed by a first cooldown phase to a cooldown temperature T2. The temperature profile decreases hereby linearly over the cooldown time of the first phase t3 to the cooldown temperature T2. The cooldown temperature T2 may range between 100° C. and a heat-up temperature T1.

In a following second cooldown phase, the temperature decreases linearly in the cooldown time of the second phase t4. The temperature drop may take place substantially to room temperature or to a desired target temperature (not shown here). It is also conceivable to provide further cooldown phases, although not shown here.

FIG. 5b shows a graphical illustration of a temperature profile which resembles the temperature profile of FIG. 5a, with the difference that the temperature rise during the heat-up time t1 assumes a progressive course and the cooldown during the first and second phases assumes degressive temperature profiles over the time t3, t4, respectively.

FIG. 5c shows in addition to FIGS. 5a, 5b that the temperature profile during the heat-up time t1 is degressive and during the individual cooldown phases displays a progressive course of the temperature decrease over the time t3, t4, respectively.

It is also conceivable within the scope of the invention to provide the temperature profile over the time with combinations of progressive, linear and degressive profiles and also to realize a temperature change with progressive, linear and degressive profiles during the hold time t2.

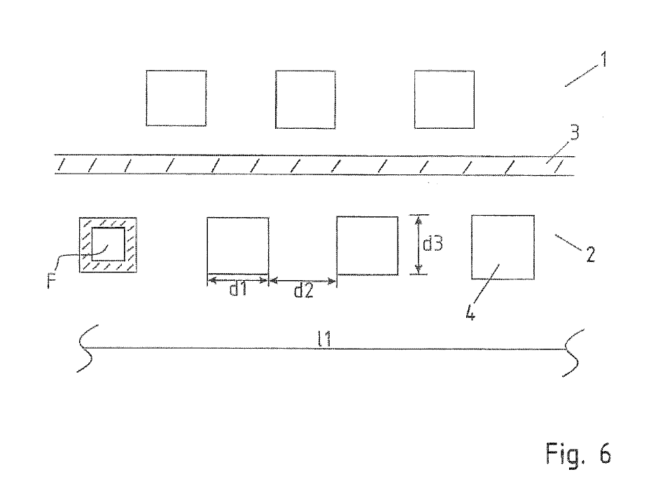

FIG. 6 shows a simplified schematic cross sectional view of an arrangement of first inductor 1 and second inductor 2 with a structural part 3 being placed in-between. The individual induction loops 4 have a cross sectional area F which relates to a hollow space located in the induction loop. The hollow space is designated in generally by a length l1, with the length l1 representing the entire length of the induction loop 4 through which a coolant flows without interruption. Reference signs d1, d2, d3 designate in FIG. 6 distances between induction loops and geometric dimensions of the induction loop 4. The following table illustrates selected values:

| | | | | Especially |
|---|---|---|---|---|
| | Preferable | Especially | Preferred | Preferred |
| $\frac{F}{{l}_{1}} [ \frac{{mm}^{2}}{mm} ]$ | $\frac{9}{1000}$ | $\frac{1}{80}$ | $\frac{1}{50}$ | $\frac{1}{30}$ |
| d₁ [mm] | 3 ≦ d₁ ≦ 15 | 4 ≦ d₁ ≦ 10 | 4 ≦ d₁ ≦ 8 | 4 ≦ d₁ ≦ 6 |
| $\frac{{d}_{1}}{{d}_{2}}$ | $\frac{10}{1} ≦ … ≦ \frac{1}{4}$ | $\frac{5}{1} ≦ … ≦ \frac{1}{3}$ | $\frac{2}{1} ≦ … ≦ \frac{1}{2}$ | $\frac{2}{1} ≦ … ≦ \frac{1}{1}$ |
| $\frac{{d}_{1}}{{d}_{3}}$ | $\frac{1}{5} ≦ … ≦ \frac{10}{1}$ | $\frac{1}{4} ≦ … ≦ \frac{5}{10}$ | $\frac{1}{3} ≦ … ≦ \frac{3}{1}$ | |

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A tool for local heat treatment of a metallic structural part, comprising:
a first inductor arranged above a first side of a region of the structural part undergoing local heat treatment at a first distance to the first side; and
a second inductor arranged at a second side of the region in opposition to the first side,
wherein at least one of the first and second inductors has induction loops arranged in the shape of a meander.

2. The tool of claim 1, wherein the structural part is a hot-formed and press-hardened structural part.

3. The tool of claim 1, wherein the first and second inductors are arranged in offset relationship.

4. The tool of claim 3, wherein the offset relationship is realized by positioning a positive amplitude in the meander shape of the first inductor in opposition to a negative amplitude in the meander shape of the second inductor.

5. The tool of claim 3, wherein the offset relationship corresponds to 0.25 to 0.75 times a length of a period of the meander shape.

6. The tool of claim 3, wherein the offset relationship corresponds to half a length of a period of the meander shape.

7. The tool of claim 1, wherein the first and second inductors have each induction loops arranged in the shape of a meander, with a period of the meander shape of the induction loops of the first inductor substantially corresponding to a period of the meander shape of the induction loops of the second inductor.

8. The tool of claim 1, wherein at least one of the first and second inductors is supported for movement.

9. The tool of claim 1, wherein the second inductor is arranged at a second distance to the structural part.

10. The tool of claim 1, wherein the first distance is variable.

11. The tool of claim 9, wherein the second distance is variable.

12. The tool of claim 1, wherein the induction loops have a tubular configuration.

13. The tool of claim 1, wherein the induction loops are tubes for allowing flow of a coolant there through.

14. The tool of claim 13, wherein the tubes are made of copper alloy.

15. A method for local heat treatment of a metallic structural part, comprising:
inserting the structural part in a holder in a position in which a region of the structural part is intended to undergo local heat treatment by a first inductor;
placing a restraining mechanism with a second inductor above the region such that the first and second inductors are arranged in offset relationship in longitudinal direction of the structural part; and
heat treating the region.

16. The method of claim 15, wherein the structural part is a hot-formed and press-hardened structural part.

17. The method of claim 15, wherein the heat treating step includes a relative movement of at least one of the first and second inductors.

18. The method of claim 15, wherein the first and second inductors move in relation to the structural part at an absolute constant distance from one another, wherein the relative movement is less than 20 mm.

19. The method of claim 17, wherein the relative movement is executed in an oscillating manner.

20. The method of claim 15, wherein the first inductor is arranged at a variable distance to the structural part.

21. The method of claim 15, wherein the second inductor is arranged at a variable distance to the structural part.

22. The method of claim 15, wherein the heat treating step includes heating up the region to a temperature in a temperature range between 500° C. and 900° C., maintaining the region at the heat-up temperature for a hold time, and cooling down the region from the heat-up temperature in at least one phase.

23. The method of claim 22, wherein the heat-up temperature ranges between 550° C. and 800° C.

24. The method of claim 22, wherein the heat-up temperature ranges between 700° C. and 800° C.

25. A tool arrangement for local heat treatment of a metallic structural part, comprising a tool having a first inductor arranged in a marginal area above a region of the structural part undergoing local heat treatment and including induction loops having a meander shape to encompass the structural part from a top side of the structural part to a bottom side thereof, wherein the induction loops on the opposite sides are arranged at an offset which is 0.25 to 0.75 times a length of a period of the meander shape.

26. The tool arrangement of claim 25, wherein the structural part is a hot-formed and press-hardened structural part.

27. The tool arrangement of claim 25, wherein the offset corresponds to half the length of the period of the meander shape.
